(19) United States
(12) Patent Application Publication
(10) Pub. No.: US 2009/0148569 A1
(43) Pub. Date: Jun. 11, 2009

(54) FAUX CAKE WITH EDIBLE PORTION

(76) Inventor: Elaine Kimberly Aya, Grandville, MI (US)

Correspondence Address: KANE & CO., PLC, 29 PEARL ST. NW, 410 FEDERAL SQUARE BUILDING, GRAND RAPIDS, MI, 49503, US

(21) Appl. No.: 12/206,820

(22) Filed: Sep. 9, 2008

Related U.S. Application Data
(60) Provisional application No. 61/012,476, filed on Dec. 10, 2007.

(51) Int. Cl. A23G 3/54

(52) U.S. Cl. 426/104

(57) ABSTRACT

A simulated edible cake, comprising a base, a core having a predetermined shape attached to the base and a portion of the core including a notch for receiving at least one piece of edible cake. The core of the cake is covered with at least one layer of edible crust to provide the cake with a desired exterior design. The edible cake is shipped to the desired location in a specialized container having a receiver formed therein for fix the base and centering the cake within the container for shipment.

### CROSS REFERENCE TO RELATED APPLICATION

This application claims priority under 35 U.S.C. §120 to prior filed U.S. provisional patent application Ser. No. 61/012,476 filed Dec. 10, 2007, the contents of which are incorporated herein by reference.

### BACKGROUND OF THE INVENTION

1. Field of the Invention

This invention generally relates to cakes and specifically to an imitation cake decorated with an edible exterior shell to simulate a real cake, and which can be shipped long distances in a container. More specifically the invention concerns an imitation cake having a compartment for holding an edible portion of real cake which is covered with the same edible exterior shell to make it appear as a real cake. The invention includes a container and method of retention that preserves the cake during shipment.

2. Discussion of the Prior Art

Cakes are often the center of any party. This is rarely more true that at wedding parties. Couples about to be married spend considerable amounts of time selecting the cake design, but are often confronted with very high costs. Moreover, because of the often complicated designs, the couple risks having the cake fall into ruin during transport or during the event itself. Moreover, climate and environmental conditions often can have a serious impact on the quality of the cake. Heat and humidity can often cause the cake to be too dry or too moist. It is not an uncommon event for the couple to have excess cake leftovers at the end of the event. The disadvantages of high cost and all of the logistical events that can have a disastrous impact on the quality of a party cake are removed by the invention described below.

### SUMMARY OF THE INVENTION

According to one form of the invention, a simulated edible cake is providing including a base, a first sheet of polymeric foam having a first dimension and geometric shape and attached to the base and at least a second sheet of polymeric foam having a second dimension and geometric form mounted to an upper surface of the first sheet of polymeric foam to form a core of the imitation cake. At least one of the two sheets of polymeric foam includes a notch or removable portion where at least one piece of edible cake may be placed just prior to the special event. Covering the cake core is at least one decorative layer of edible fondant or frosting which after time becomes hardened or cured to form a durable crust about the cake core yet looks as it is was made recently. To preserve and protect the imitation cake during transport, the cake is placed inside a container having a receiver formed therein for holding the base securely during shipment.

Additional features of the invention include a two or more additional layers of fondant or frosting applied in a predetermined pattern over the first layer to provide a custom imitation cake. The multiple layers of the cake core may be held together by at least one mechanical fastener extending through the different layers and connecting to the base. The fastener helps keep the layers in position relative to one another, and provide a rigid frame.

In another embodiment of the invention, it is anticipated that the cake core may be made from a number of materials, but it is preferred that a light weight yet rigid material be used such as an open-cell or closed-cell foam to keep the weight of the cake to a minimum. The sheets of foam mats be stacked vertically upon one another and attached to one another to provide a substantially rigid structure.

In yet another embodiment of the invention, a simulated cake is provided, comprising a base, and a plurality of layers of foam disposed one above another in a substantially vertical manner to form the cake core. A bottom one of the plurality of layers of foam is attached to the base with the remaining layers of foam stacked above the bottom layer substantially vertically. Each of the layers of foam may be interconnected by at least one pin extending there through and fixed at one end to the base. At least one of the pluralities of layers of foam may include a cut-out or removable portion where the end users may later place an edible portion of cake prior to the special event to make it appear that they are eating actual cake from the imitation cake. The cake core is covered by at least one layer of fondant or frosting forming a substantially durable decorative crust. A package of uncured fondant or frosting is provided for covering over the substituted edible cake placed in the cut-out or removable portion to give the imitation cake the image of a real cake when sliced. At least a second layer of fondant or frosting may be applied over the first layer to create a unique decorative appearance suggesting that the cake is real.

This embodiment of the invention also includes a closable container having an interior volume sufficient for receiving the simulated cake therein. At least one cleat attached to an interior surface of the container is configured to receive and fix the base of the imitation cake securely within the container rendering it secure for transport.

In yet another embodiment of the invention, a durable cake is provided suitable for shipping long distances and comprises a base pan, at least two layers of foam stacked one above the other in a substantially vertical manner, at least one mechanical fastener interconnecting the layers of foam to the base pan, and at least one layer of frosting covering the layers of foam to create a durable decorative crust. A sealable container is provided having an interior volume sufficient to contain the durable cake therein. The sealable container includes at least one interior wall containing a hold down for receiving the base pan and fixing the location of the base pan relative to the interior volume of the sealable container during shipment.

### BRIEF DESCRIPTION OF THE DRAWING FIGURES

FIG. 1 is an oblique view of one embodiment of the invention:

FIG. 2 is an elevation view of the invention shown in FIG. 1;

FIG. 3 is a plan view of the invention shown in FIG. 2;

FIG. 4 is a section view of the invention shown in FIGS. 3 taken along line IV-IV;

FIG. 4a is a section view illustrating another embodiment of the invention;

FIG. 5 is an oblique view of a container used for storing and shipping the invention shown in FIGS. 1-4;

FIG. 6 is an elevation view of one side of the container shown in FIG. 5; and

FIG. 7 is a plan view of the container shown in FIG. 5.

### DETAILED DESCRIPTION OF THE INVENTION

For purposed of the following description, the terms “upper”, “lower”, “right”, “left”, “rear”, “front”, “vertical”, “horizontal” and derivatives thereof shall relate to the invention as oriented in the respective figure. However, the invention may assume various alternative orientations except where expressly specified to the contrary. It is also to be understood that the specific devices and processes illustrated in the attached drawings and described in the following specification are simply exemplary embodiments of the inventive concepts defined in the specification and any appended claims. Specific dimensions and other physical characteristics relating to the embodiments disclosed herein are not to be considered limiting unless the claims expressly state otherwise.

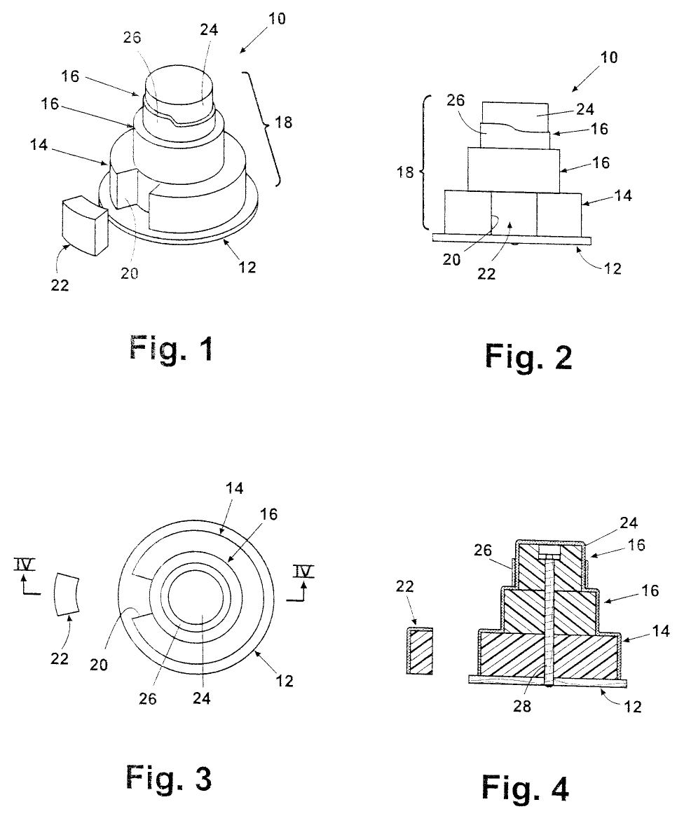

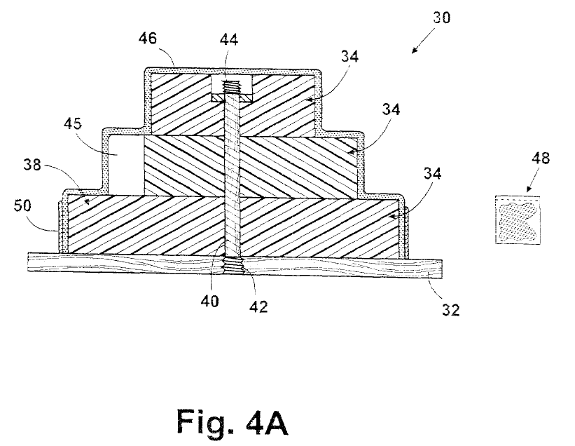

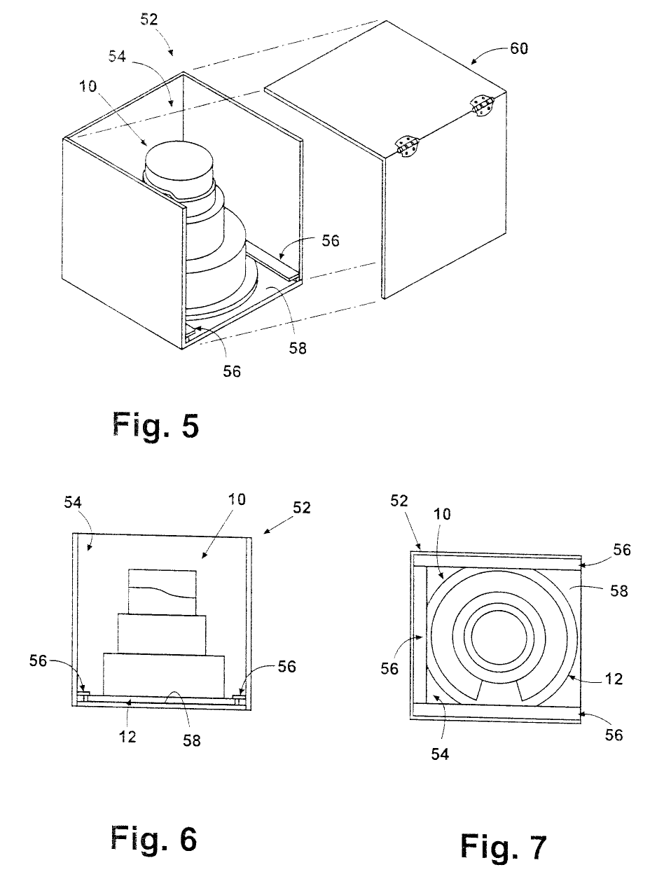

Referring to FIGS. 1-4, one embodiment 10 of a simulated cake with accommodation for edible portion is shown which can be shipped substantially long distances and unpackaged appearing as if it was a real cake made recently. The simulated cake 10 is comprised of a base 12, a first sheet 14 of foam having a first dimension and geometric shape attached to the base 12, and at least a second sheet 16 of foam of a second dimension and geometric form mounted to an upper surface of the first sheet 14 of foam. Together the various sheets 14, 16 form a core 18 of the cake 10. At least one of the two sheets or layers 14, 16 of foam may include a notch or removable portion 20 where at least one piece of edible cake 22 may be placed just prior to the special event. Covering the cake core 18 is at least one decorative layer 24 of edible fondant or frosting which after time hardens or cures to form a durable crust about the cake core 18, yet looks as if it was made recently.

It is anticipated that multiple layers or coatings of fondant or frosting 26 may be applied in a predetermined pattern over the first layer 24 to provide a custom imitation cake. The multiple layers 14, 16 of the cake core 18 may be held together by at least one mechanical fastener 28 extending through the different layers and connecting to the base. Example of suitable types of mechanical fasteners include dowels, pins, threaded rods, holds, screws, and equivalent mechanisms extending from the uppermost layer or sheet such as 16 downward through the underlying layers or sheets such as 14, and attached to the base 12. It is also anticipated that adhesives may be found to be suitable to bond the different layers together which may be used separately or in addition to the mechanical fasteners such as those described above. Using fasteners and/or adhesives, the resulting structure is much more cohesive than free floating sheets, and the fasteners and adhesives help keep the layers in position relative to one another, and provide a rigid frame or core 18.

It is anticipated that the cake core 18 may be made from a number of materials to provide a substantially rigid yet lightweight framework upon which the edible fondant or frosting is applied. For example, it is envisioned that a suitable light weight yet rigid material that can be used to form the core 18 is open-cell foam such as sold under the brand name Styrofoam and similar or related materials. The open cell structure of the foam provides good adhesion and bonding for the crust 24 of edible fondant or frosting applied to the core 18. The interstices offered by the open cell foam structure provide increased surface area to receive the crust 24 providing a good mechanical adhesion. Other types of materials may also be found to be suitable such as some closed-cell foam such as some expanded polystyrene which also offers a suitably rigid yet lightweight framework for creating the core 18. The expanded polystyrene material would be especially suitable if it is desired to later remove or replace the decorative layers 24, 26 covering the core 18.

In yet another embodiment of the invention a simulated cake 30 is provided, comprising a base 32, and a plurality of layers 34 of foam disposed one above another in a substantially vertical manner to form the cake core 36. A bottom one 38 of the layers 34 is attached to the base 32 with the remaining layers 34 stacked above the bottom layer 38 substantially vertically. Each of the layers 34 may be interconnected by at least one pin 40 extending there through and fixed at one end 42 to the base. The opposite end 44 of the pin is attached to the uppermost layer in the core 36. At least one of the layers may include a cut-out or removable portion 45 where the end user may later place a food item such as a piece of cake prior to the event to make it appear that they are actually cutting a real cake. The cake core 36 is covered by at least one layer of fondant or frosting forming a substantially durable decorative crust 46. A package of uncured matching fondant or frosting 48 is provided for covering over the substituted edible cake placed in the cut-out or removable portion 44 to give the imitation cake the image of a real cake when sliced. At least a second layer of fondant or frosting 50 may be applied over the first layer to create a unique decorative appearance suggesting that the cake is real.

The invention also includes a closable container 52 having an interior volume 54 sufficient for receiving the simulated cake therein. At least one cleat 56 attached to an interior surface 58 of the container is configured to receive and fix the base of the imitation cake securely within the container rendering it secure for transport. The container is closed with a top 60 and readied for shipment or transport.

In yet another embodiment of the invention, a durable cake is provided suitable for shipping long distances and comprises a base pan, at least two layers of foam stacked one above the other in a substantially vertical manner, at least one mechanical fastener interconnecting the layers of foam to the base pan, and at least one layer of frosting covering the layers of foam to create a durable decorative crust. A sealable container is provided having an interior volume sufficient to contain the durable cake therein. The sealable container includes at least one interior wall containing a hold down for receiving the base pan and fixing the location of the base pan relative to the interior volume of the sealable container during shipment.

The invention also contemplates a new method of business, more specifically cake rental. The inventive method contemplates one or more locations geographically distributed throughout a given market such as the United States. Customers may visit one of the locations, or alternatively, access a central location via the worldwide web. At either location the customer may view select a cake style and design from a menu or may elect to design their own. The customer selects the cake style and design and places the order, providing payment for the order. Once the order is placed, the closest geographic location is notified of the order and the cake is created. First the style of the cake is crafted from either a preselected preform or is made to the customer specifications. The selected fondant or frosting covering is then applied to the cake exterior according to the order specifications. A package of the fondant or frosting is included with the cake so that the customer can conceal the edible cake or other foods in the removable portion of the cake just prior to the event.

Once the cake is completed, the cake, sitting on the base described above, is placed in a specially designed crate or container, also described above, and shipped to the customer's location indicated on the order form. There the customer remove the cake from the container, places the customer's selected edible portion in the provided location, and is free to conceal the edible material with the provided fondant or frosting to make it appear as if the entire cake is real. After the event, the customer simply places the imitation cake back into the custom container and returns the cake to the business using conventional shipping methods.

If the cake is one of a preselected style and design, the fondant selected for the exterior design of the cake is crafted so as to be sufficient durable for several rentals. As the exterior design becomes scratched or damaged, the fondant or frosting is repaired using traditional cake decorating methods so as to make the cake appear new or fresh once again. Cakes which were specifically designed by the customer may saved and placed on the standard menu of available designs, or the fondant or frosting may be removed using soap and water leaving the underlying foam core foundations for reuse.

In the foregoing description, it will be readily appreciated by those skilled in the art that modifications may be made to the invention without departing from the concept disclosed herein. Such modifications are to be considered as included in the following claims, unless these claims by their language expressly state otherwise.

I claim:

1. A simulated edible cake, comprising: a base; a first sheet of polymeric foam having a first dimension and geometric shape and attached to said base; a second sheet of polymeric foam having a second dimension and geometric form mounted to an upper surface of said first sheet of polymeric foam, one of said two sheets of polymeric foam including a notch for receiving at least one piece of edible cake; at least one layer of edible fondant covering each of said first and second sheets of polymeric foam; and a container having a receiver formed therein for receiving said base and centering the wedding cake within the container for shipment.

2. The simulated edible cake of claim 1, further comprising: a second layer of fondant applied in a predetermined pattern over said at least one layer of fondant covering.

3. The simulated edible cake of claim 1, further comprising: at least one mechanical fastener extending between each of said first and second sheets of polymeric foam for retaining each sheet of polymeric foam in a position relative to one another.

4. The simulated edible cake of claim 1, wherein said first and second sheets of polymeric foam are made from a open-cell foam.

5. The simulated edible cake of claim 1, wherein said first and second sheets of polymeric foam are made from closed-cell foam.

6. The simulated edible cake of claim 1, further comprising a plurality of sheets of polymeric foam stacked vertically upon one another and attached to one of said first and said second sheets of polymeric foam.

7. The simulated edible cake of claim 1, further including a package of fondant for covering an edible material disposed within said notch formed in one of said first and second sheets of polymeric foam to conceal the edible material as if integral with the cake.

8. The simulated edible cake of claim 1, wherein said fondant is substantially cured and hardened to form an exterior shell over said first and second sheets of polymeric foam.

9. The simulated edible cake of claim 1, wherein said plurality of sheets of polymeric foam are substantially annular, with said first sheet having a diameter larger than a diameter of any subsequent sheet.

10. A simulated cake, comprising: a base; a plurality of layers of foam disposed one above another in a substantially vertical manner, a bottom one of said plurality of layers of foam attached to said base and others of said plurality of layers of foam stacked above said bottom layer substantially vertically to form a peak, each of said plurality of layers interconnected to an adjacent layer by at least one pin extending there between; at least one of said plurality of layers of foam including a cut-out portion; said plurality of layers of foam covered by at least one layer of fondant forming a substantially durable crust over said plurality of layers of foam; and a package of uncured fondant for concealing the edible material placed in said cut-out portion.

11. The simulated cake of claim 10, further comprising a closable container having an interior volume sufficient for receiving the simulated cake therein, and at least one cleat attached to in an interior surface of said container for receiving and fixing said base to the container and fixing the simulated cake therein.

12. The simulated cake of claim 10, further comprising: a second layer of fondant over at least portions of said first layer of fondant, said second layer of fondant creating a decorative crust over said plurality of layers of foam and said first layer of fondant.

13. The simulated cake of claim 10, wherein said plurality of layers of foam include layers of open cell foam.

14. The simulated cake of claim 10, wherein said plurality of layers of foam include layers of closed-cell foam.

15. The simulated cake of claim 10, wherein said at least one pin interconnecting adjacent layers of foam to one another include dowels, screws, lag bolts, and mechanical fasteners,

16. A durable cake suitable for shipping long distances, comprising:
a base pan
at least two layers of foam staked one above the other in a substantially vertical manner, one of said at least two layers of foam forming a bottom layer and the other of said at least two layers of foam forming an upper layer above said bottom layer, at least one of said at least two layers of foam including a cut-out portion for later receiving an edible food material therein;
at least one mechanical fastener interconnecting said bottom layer of foam to said base pan, and another mechanical fastener interconnecting said bottom layer to said upper layer;
at least one layer of fondant covering said plurality of layers of foam to create a durable decorative crust; and
a sealable container having an interior volume sufficient for fitting the durable cake therein, said sealable container having at least one interior wall including a hold down for receiving said base pan and fixing a location of said base pan relative to said interior volume of the sealable container during shipment.

17. The durable cake of claim 16, further comprising: a package of uncured fondant for covering edible material deposited within said cut-out portion formed in at least one of said plurality of layer of foam.

18. The durable cake of claim 16, further wherein said at least one mechanical fastener is selected from the group of pins, dowels, bolts, and screws.

19. The durable cake of claim 16, wherein said plurality of layers of foam include closed-cell foam.

20. The durable cake of claim 16, wherein said plurality of layers of foam include open-cell foam.

21. The durable cake of claim 16, wherein said container includes a means for engaging said base pan for holding said base pan and said plurality of layers of foam in a fixed position relative to said container interior while said container is closed.
